(19) United States
(12) Patent Application Publication
(10) Pub. No.: US 2005/0267876 A1
(43) Pub. Date: Dec. 1, 2005

(54) Electronic apparatus

(75) Inventors: Hiroyuki Watanabe, Ome-shi (JP); Makoto Taki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/138,903

(22) Filed: May 27, 2005

(30) Foreign Application Priority Data
May 31, 2004 (JP) 2004-162412

(51) Int. Cl. G06F 17/30

(52) U.S. Cl. 707/3

(57) ABSTRACT

An electronic apparatus of this invention is capable of performing wireless communication complying with, for example, Bluetooth(R), searches for wireless devices existing nearby, and displays a screen for selecting members to be summoned to a conference from the devices searched for. Then, objects representing the members selected on the screen and an object representing the present apparatus are arranged at equal intervals on a circle to cause these objects to be regarded as attendees sitting at a round table in the conference room. According to an operation performed on a displayed object (for example, the icon of a file to be transferred is dragged and dropped on the object of a destination member), data transmission and reception to and from each member is performed.

### CROSS-REFERENCE TO RELATED APPLICATIONS

This application is based upon and claims the benefit of priority from prior Japanese Patent Application No. 2004-162412, filed May 31, 2004, the entire contents of which are incorporated herein by reference.

### BACKGROUND OF THE INVENTION

1. Field of the Invention

The present invention relates to the technique for controlling data transmission and reception between electronic apparatuses connected to one another via, for example, a wireless LAN or Bluetooth(R).

2. Description of the Related Art

In recent years, wireless communication technology, including wireless LANs and Bluetooth(R), has been making remarkable progress. In offices and the like, connecting electronic apparatuses to one another in a cableless manner has become increasingly mainstream. Since cableless connection can be made easily, it points to a sharp rise in the opportunity of exchanging files via such communication. Against this backdrop, various methods of transferring a desired file to a desired addressee simply and reliably have been proposed (refer to, for example, Jpn. Pat. Appln. KOKAI Publication No. 2002-132618).

In the method disclosed in Jpn. Pat. Appln. KOKAI Publication No. 2002-132618, each user can transfer a desired file to a desired addressee simply by dragging and dropping the icon of the file to be transferred on the avatar of the addressee shown in a virtual space.

A mechanism for providing the user with this type of interface, including the method disclosed in Jpn. Pat. Appln. KOKAI Publication No. 2002-132618, is generally constructed by using a server unit independent of the electronic apparatus used by each user. Consequently, the operation of each user related to file transfer is simplified, but the size of the entire system becomes larger.

In addition, for example, when the user wants to transfer a file to a plurality of addressees belonging to the same group, the user must transfer the file as many times as the number of addressees. Although the size of the system has become larger, data transmission and reception do not take into account the case where there are a plurality of addressees.

### BRIEF SUMMARY OF THE INVENTION

According to an embodiment of the present invention, an electronic apparatus comprises means for searching other electronic apparatuses to be communicated; a memory configured to store data;

a display controller configured to display first objects representing the other electronic apparatuses searched by the searching means, a second object representing the present apparatus, a third object representing a common area for the present apparatus to share the data with the other electronic apparatuses represented by the first objects, and a fourth object representing the data; and a controller configured to share the data represented by the fourth object with the other electronic apparatuses represented by the first objects, when a specific operation for relating the fourth object to the third object is conducted.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 shows a system configuration of an electronic apparatus according to an embodiment of the present invention;

FIG. 2 shows a communication environment of six electronic apparatuses assumed in the embodiment;

FIG. 3 shows an example of a menu list displayed by a network utility operating on the electronic apparatus of the embodiment;

FIGS. 4A and 4B show examples of displaying the result of the search for wireless devices made by the network utility (device search control program) operating on the electronic apparatus of the embodiment;

FIG. 5 shows an example of a conference room creating screen displayed by the network utility (conference room control program) operating on the electronic apparatus of the embodiment;

FIG. 6 shows an example of a conference room name input screen displayed by the network utility (conference room control program) operating on the electronic apparatus of the embodiment;

FIG. 7 shows an example of a conference room screen for the convener displayed by the network utility (conference room control program) operating on the electronic apparatus of the embodiment;

FIG. 8 shows an example of an advertising balloon representation given when the network utility (conference room control program) operating on the electronic apparatus of the embodiment has received an invitation to a conference room;

FIG. 9 shows an example of a pop-up screen for determining whether to participate in the conference room displayed by the network utility (conference room control program) operating on the electronic apparatus of the embodiment;

FIG. 10 shows an example of a conference room screen for conference members displayed by the network utility (conference room control program) operating on the electronic apparatus of the embodiment;

FIG. 11 is a diagram to help explain first data transmission and reception the convener can perform using the network utility (conference room control program) operating on the electronic apparatus of the embodiment;

FIG. 12 is a first diagram to help explain second data transmission and reception the convener can perform using the network utility (conference room control program) operating on the electronic apparatus of the embodiment;

FIG. 13 is a second diagram to help explain second data transmission and reception the convener can perform using the network utility (conference room control program) operating on the electronic apparatus of the embodiment;

FIG. 14 is a diagram to help explain third data transmission and reception the convener can perform using the network utility (conference room control program) operating on the electronic apparatus of the embodiment;

FIG. 15 is a diagram to help explain three types of data transmission and reception the convener can perform using the network utility (conference room control program) operating on the electronic apparatus of the embodiment;

FIG. 16 is a first diagram to help explain second data transmission and reception the conference members can perform using the network utility (conference room control program) operating on the electronic apparatus of the embodiment;

FIG. 17 is a second diagram to help explain second data transmission and reception the conference members can perform using the network utility (conference room control program) operating on the electronic apparatus of the embodiment;

FIG. 18 shows an example of a group setting screen displayed by the network utility (conference room control program) operating on the electronic apparatus of the embodiment;

FIG. 19 is a flowchart to help explain the operation flow of the electronic apparatus when the convener creates a conference room in the embodiment; and

FIG. 20 is a flowchart to help explain the operation flow of the electronic apparatus when a conference member participates in the conference in the embodiment.

### DETAILED DESCRIPTION OF THE INVENTION

Hereinafter, referring to the accompanying drawings, an embodiment of the present invention will be explained.

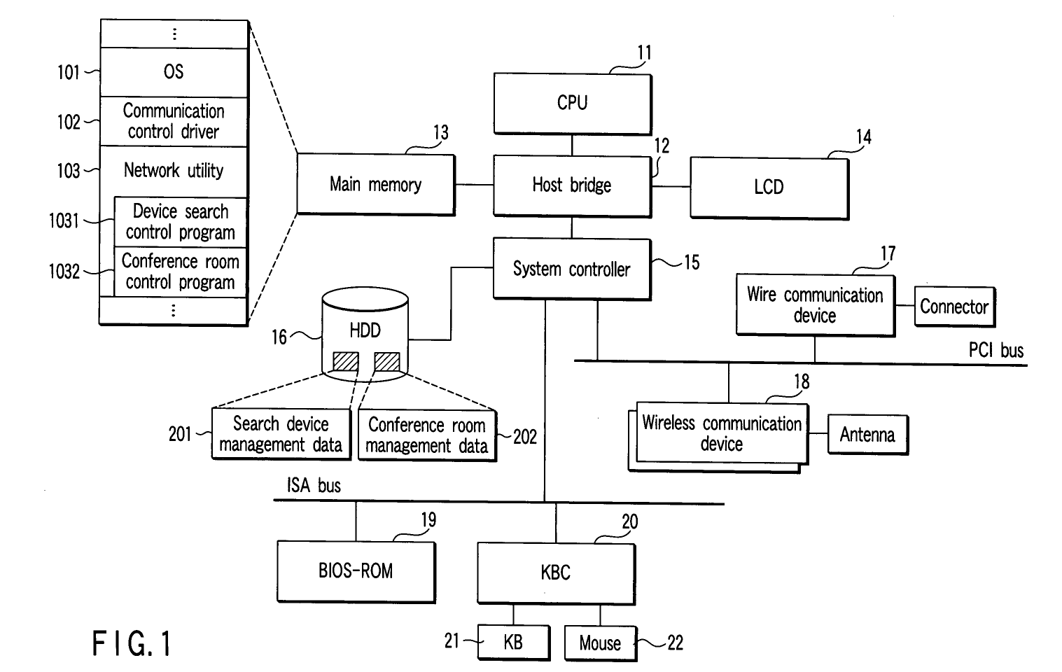

FIG. 1 shows a system configuration of an electronic apparatus according to the embodiment. The electronic apparatus, such as a battery-powered notebook computer, comprises a CPU 11, a host bridge 12, a main memory 13, a liquid crystal display (LCD) 14, a system controller 15, a magnetic hard disk drive (HDD) 16, a wire communication device 17, a wireless communication device 18, a basic input/output system (BIOS) ROM 19, a keyboard controller (KBC) 20, a keyboard (KB) 21, and a mouse 22.

The CPU 11, which supervises the entire operation of the electronic apparatus, executes various programs, including an operating system (OS) 101 loaded from the HDD 16 into the main memory 13, and the BIOS stored in the BIOS ROM 19. The host bridge 12 has a bridge function of connecting the local bus included in the CPU 11 to a system bus, a memory control function of accessing the main memory 13 and a display controller function of performing display control of the LCD 14.

The main memory 13, which is a storage medium acting as the main memory of the electronic apparatus, stores the operating system 101, a communication control driver 102 for driving the wire communication device 17 or wireless communication device 18 and a network utility 103 explained later. Moreover, in the main memory 13, various data used by these various programs are also stored temporarily. The LCD 14, which plays an output role in the user interface of the electronic apparatus, displays the image data created by various programs executed by the CPU 11.

The system controller 15 has a disk control function of controlling access to the HDD 16 and an arbiter function of arbitrating data transfer between the PCI bus and ISA bus provided in the electronic apparatus. The HDD 16, which is a storage medium serving as an external memory of the electronic apparatus, stores various programs and a large amount of various data as an auxiliary device of the main memory 13.

The wire communication device 17 and wireless communication device 18 both perform data transmission and reception between the electronic apparatus and another one. The wire communication device 17 executes data transmission and reception via a wire communication path complying with, for example, Ethernet(R). The wireless communication device 18 executes data transmission and reception via, for example, a wireless LAN (conforming to IEEE 802.11b or the like) or a wireless communication path conforming with Bluetooth(R). Here, suppose two wireless communication devices 18 are provided, one for a wireless LAN and the other for Bluetooth(R).

The BIOS ROM 19 is a storage medium which stores BIOS, a program for driving various types of peripheral devices provided in the electronic apparatus. The KBC 20, which plays an input role in the user interface of the electronic apparatus, transmits the operations on the KB 21 and mouse 22 to the CPU 11 via an internal register.

Suppose each user carries with him or her an electronic apparatus with the above configuration, that is, an electronic apparatus in which the network utility 103 has been installed, and uses, for example, word-processing software and spreadsheet software. The network utility 103, which is a resident program, is always in operation while the power supply of the electronic apparatus is on. Here, suppose six electronic apparatuses PC(A) 1 to PC(F) 1 are in a state where they can transmit and receive data.

Specifically, two electronic apparatuses PC(A) 1 and PC(B) 1 are in a state where they can perform both of data transmission and reception via access point (AP) 2 complying with the wireless LAN and data transmission and reception complying with Bluetooth(R). Two electronic apparatuses PC(C) 1 and PC(D) 1 are in a state where they can perform only data transmission and reception via access point (AP) 2 complying with the wireless LAN. Two electronic apparatuses PC(E) 1 and PC(F) 1 are in a state where they can perform only data transmission and reception via access point (AP) 2 complying with Bluetooth(R).

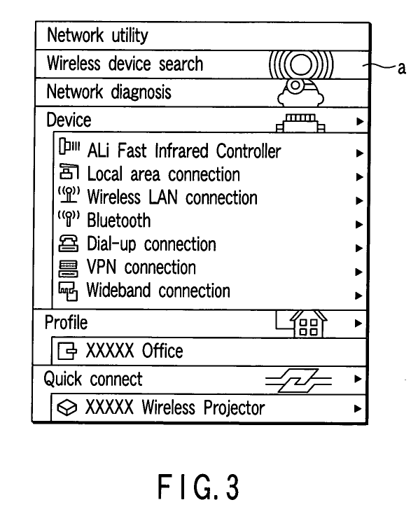

Consider, in this state, the user of PC(A) 1 tries to summon five users PC(B) 1 to PC(F) 1 and form a gathering for transmitting and receiving data files between them and sharing data files. Here, let the gathering be a conference room, the user summoning participants to the conference room be a convener, and the summoned users be conference members. In this case, the user of PC(A) 1, the convener, first causes a menu list of the network utility 103 of FIG. 3 to be displayed and selects “Wireless device search” (menu a) from the menu list. The select operation and the click operations and others explained later are notified to the corresponding programs under the control of the operating system 101.

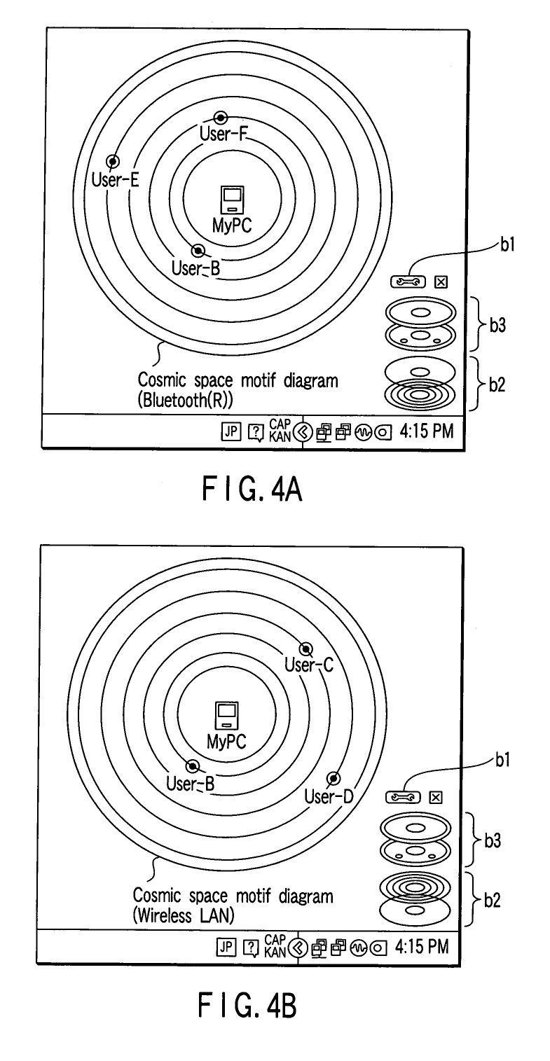

After the item has been selected, a device search control program 1031 of the network utility 103 operates and searches for wireless devices (PC(B) 1 to PC(F) 1) existing nearby, and displays the result of the search in representation formats shown in FIGS. 4A and 4B. As shown in FIG. 4A, the device search control program 1031 displays a motif diagram imitating cosmic space (or cosmic space motif diagram), with an object (My PC) representing the present device in its center, and displays objects (User-B, User-E, User-F) representing the detected wireless devices according to the radio field intensity, regarding them as heavenly bodies going around in cosmic space.

The objects representing wireless devices are displayed in such a manner that those with higher field intensity are closer to the center and those with lower field intensity are farther away from the center. To prevent the displayed direction from being misconstrued as representing the actually existing direction, the object representing a wireless object always moves on the orbit corresponding to the field intensity. Whether to search for a wireless device executing data transmission and reception conforming to the wireless LAN (or wireless LAN device) or a wireless device executing data transmission and reception conforming to Bluetooth(R) can be determined on the setting screen displayed when object b1 appearing at the lower right part of the screen is clicked. The result of the search in the motif diagram is shown by object b2 appearing at the lower right part of the screen. Here, it is assumed that, of the two disks stacked one on top of the other, the upper one corresponds to the wireless LAN and the lower one corresponds to Bluetooth(R) and that the one with a plurality of orbital paths has been selected as an object to be displayed. That is, FIG. 4A shows the result of the search for Bluetooth(R) devices. As a result, objects representing PC(B) 1, PC(E) 1, and PC(F) 1 are represented as heavenly bodies.

Then, the device search control program 1031 records the result of the search as search device management data 201 into the HDD 16. Moreover, wireless LAN devices (User-C, User-D) have also been searched for as shown in FIG. 4B. That is, suppose a search for wireless LAN devices and a search for Bluetooth(R) devices both have been made by the device search control program 1031 (all of PC(B) 1 to PC(F) 1 have been searched for).

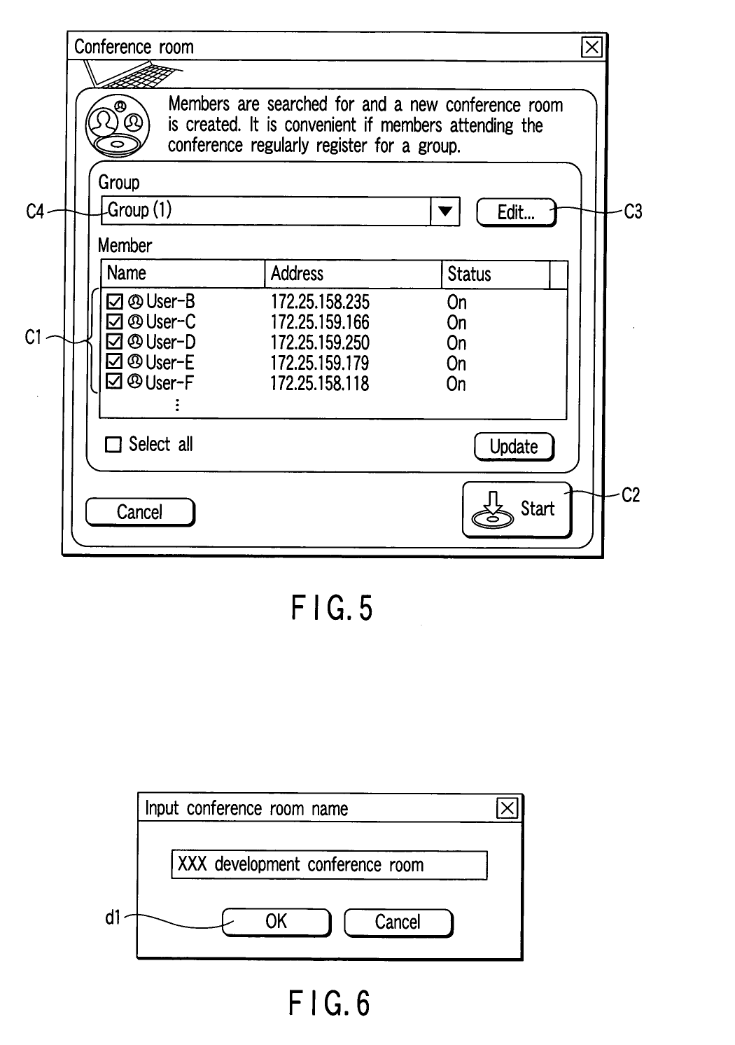

After the search for wireless devices has been made, the convener then clicks object b3 appearing at the lower right part of the screen (the search device display screen shown in FIGS. 4A and 4B) and proceeds to the work of creating a conference room. When object b3 has been clicked, a conference room control program 1032 of the network utility 103 operates. On the basis of the search device management data 201 recorded in the HDD 16, the conference room control program 1032 displays a conference room creating screen of FIG. 5.

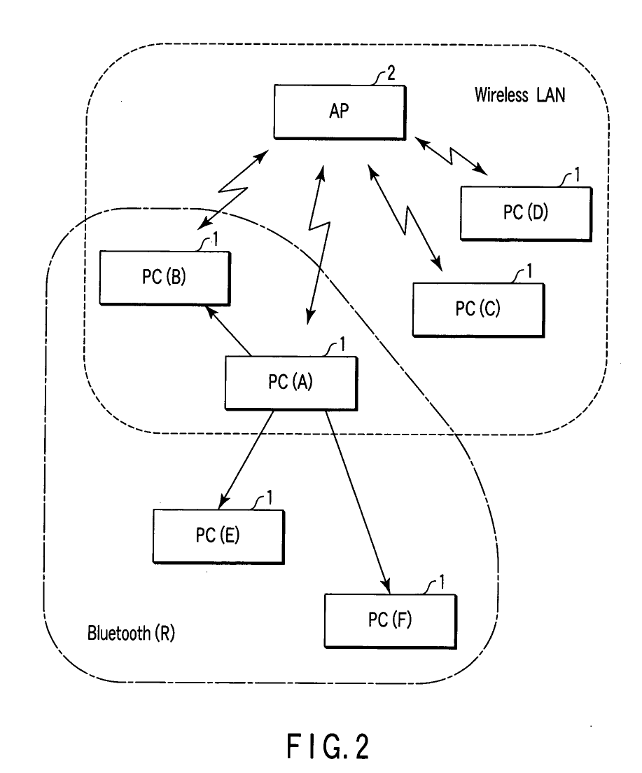

As shown in FIG. 5, on the conference room creating screen, the wireless devices searched for by the device search control program 1031 are listed as conference member candidates. Then, the convener checks the check boxes c1 of the conference members to be summoned. After having finished selecting all of the conference members, the convener clicks start button c2. USER-B shown in FIG. 5 corresponds to PC(B) 1 shown in FIG. 2 (the same holds true for the rest). Here, suppose all of PC(B) 1 to PC(F) 1 in FIG. 2 have been selected.

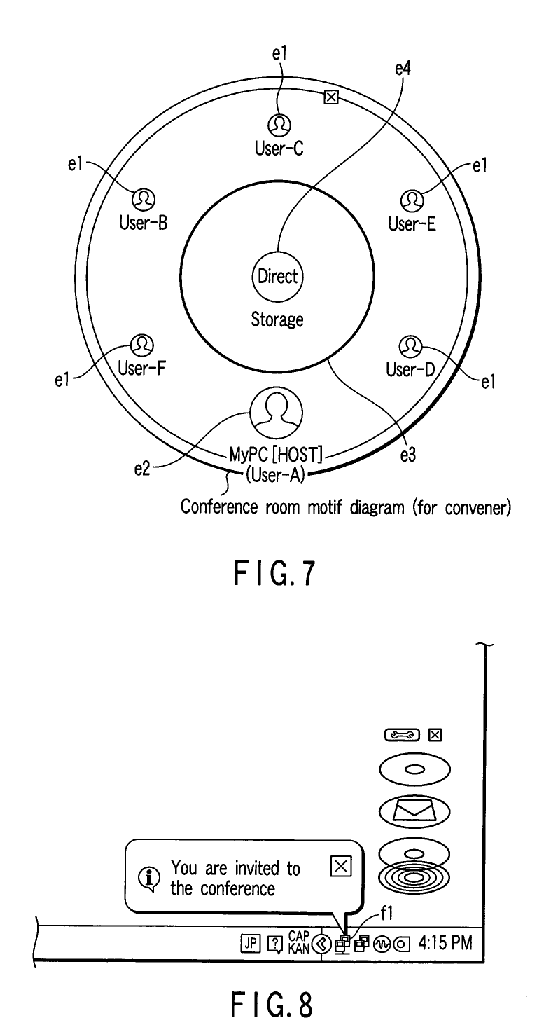

When start button c2 has been clicked, the conference room control program 1032 displays a conference room name input screen of FIG. 6. Then, the convener inputs a conference room name, such as “XXX development conference room,” and clicks OK button d1. When OK button d1 has been clicked, the conference room control program 1032 records as conference room management data in the HDD 16 the fact that that “XXX development conference room” has been created with PC(A) 1 being a convener and PC(B) 1 to PC(F) 1 being conference members. At the same time, the conference room control program 1032 asks the wireless device of each of the conference members whether to attend the conference and displays a conference room screen on which a motif diagram imitating a conference room (or conference room motif diagram (for the convener)) of FIG. 7 is shown. The details of the screen will be explained later.

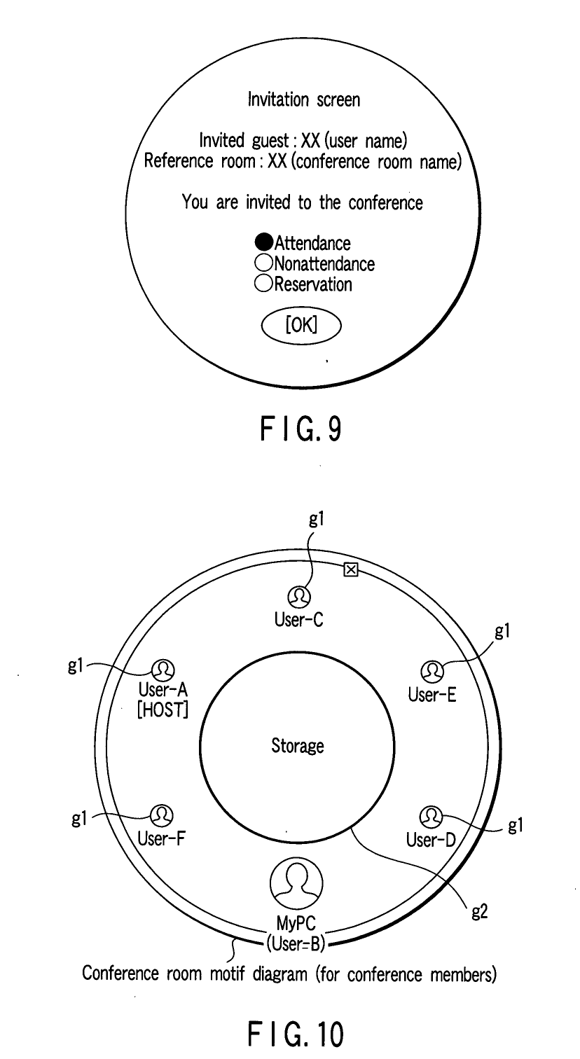

On the other hand, in the electronic apparatuses which have received the inquiry as to whether to attend the conference, that is, in each of the electronic apparatuses PC(B) 1 to PC(F) 1, the conference room control program 1032 of the network utility 103 operates and gives a balloon representation as shown in FIG. 8. The balloon representation is used to inform the user that he or she is asked whether to participate in a conference room. Looking at the balloon, each user clicks icon f1 of the network utility 103 displayed in the task tray. When icon f1 has been clicked, the conference room control program 1032 displays a pop-up screen shown in FIG. 9, acquires data about whether each user participates in the conference room, and sends back the result to PC(A) 1, the convener. If “participation (attendance)” is selected, the conference room control program 1032 displays a conference room screen on which a motif diagram imitating a conference room of FIG. 10 (or conference room motif diagram (for conference members)) appears.

At PC(A) 1 serving as the convener, the conference room screen of FIG. 7 is displayed. Using the conference room screen, the convener can perform the following data transmission and reception. In FIG. 7, objects e1 (first objects) represent the collected participating members. They together with object e2 (a second object), the convener, are arranged concentrically at equal intervals. This makes it possible to provide an interface which can produce an image as if all of the participants sit at a round table in the conference room and, by operating on the sitters, perform data transmission and reception easily and reliably.

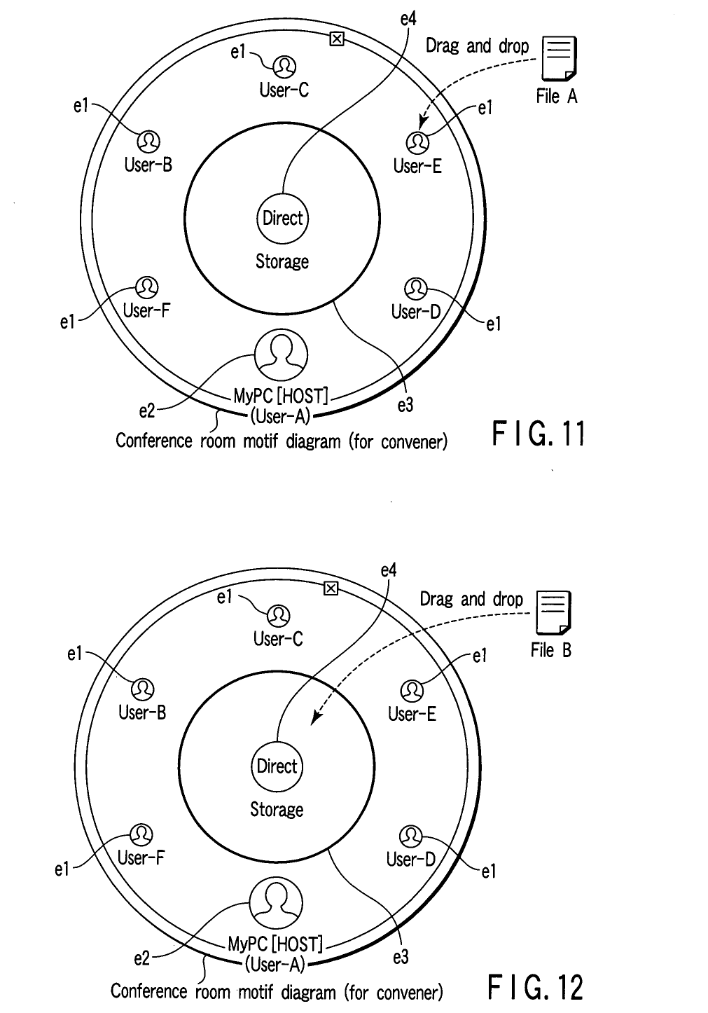

First, the convener can perform data transmission and reception to and from each conference member separately. For instance, when wanting to transfer a text file created by word-processing software to a certain conference member, the convener has only to drag and drop the icon of the text file (file A) on object e1 representing the addressee conference member as shown in FIG. 11. The operation may also be performed by clicking/double-clicking the object e1 with the icon of the text file (file A) being selected. After the drag-and-drop operation, the conference room control program 1032 sends the text file to the addressee conference member by wireless communication complying with the wireless LAN or Bluetooth(R). Since PC(B) 1 can perform wireless communication by both of the wireless LAN and Bluetooth(R), it is searched for as a wireless LAN device and a Bluetooth(R) device, when the device search control program 1032 searches for a wireless device. In this case, the conference room control program 1032 informs both of them of an inquiry as to whether to participate in the conference room. Then, the conference room control program 1032 accepts only the participation notice received earlier and, from this point on, executes data transmission and reception to and from the accepted type of wireless device. Performing such control enables wireless LAN devices and Bluetooth(R) devices to be mixed as participating members in the conference room created by the conference room control program 1032.

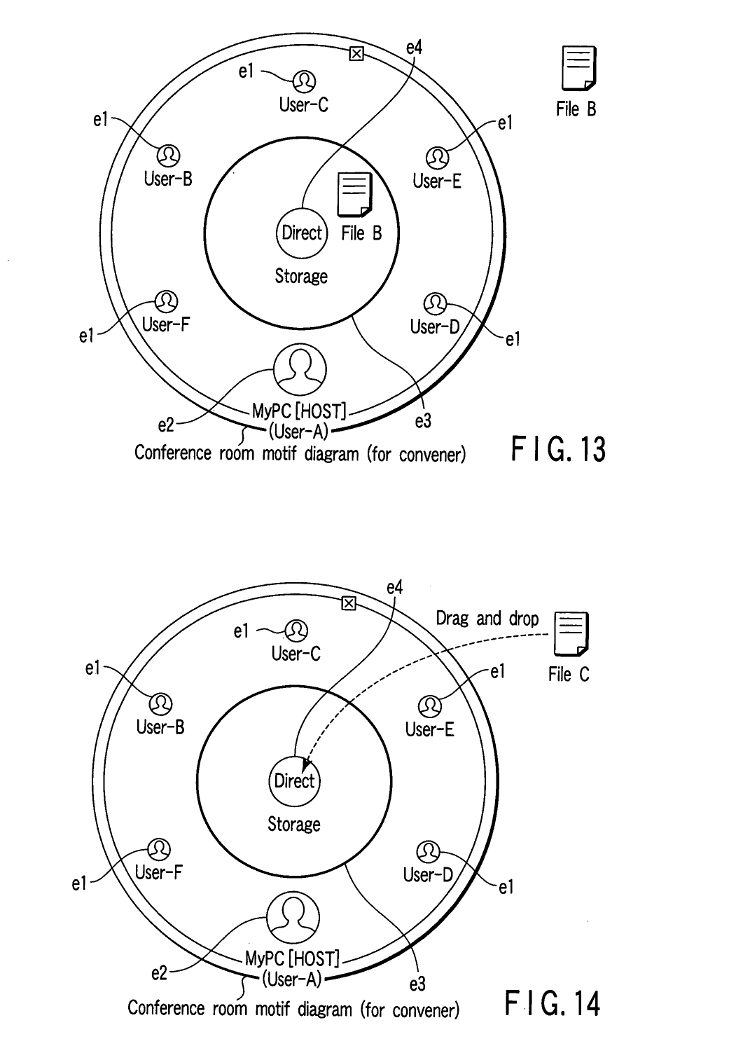

Second, the convener can open the data he or she has to all of the conference members. That is, the data the convener has can be shared with all of the conference members or be treated as common data. Doughnut-like object e3 (third object of the claim 1) is a common area in which data to be commoditized is registered. For example, to commoditize a text file created by word-processing software, the convener has only to drag and drop the icon of the text file (file B) on the object e3 as shown in FIG. 12. The operation may also be performed by clicking/double-clicking the object e3 with the icon of the text file (file B) being selected. After the drag-and-drop operation, the conference room control program 1032 records as conference room management data 202 in the HDD 16 the fact that the text file has been commoditized. At the same time, the conference room control program 1032 displays a copy of the icon on the object e3 as shown in FIG. 13 and transmits common data registration notice added with the identifier of the text file to all of the conference members. At each of the members receiving the notice, the conference room control program 1032 displays the icon of the text file in such a manner that the icon is superimposed on an object representing the same common area.

Third, the convener can transmit the same data to all of the conference members simultaneously in one operation. Circular object e4 (third object of the claim 6) placed in the central part of the round table represents a transmission area for the simultaneous transmission. For example, to transmit a text file created by word-processing software to all of the conference members, the convener has only to drag and drop the icon of the text file (file C) on the object e4 as shown in FIG. 14. The operation may also be performed by clicking/double-clicking the object e4 with the icon of the text file (file C) being selected. After the drag-and-drop operation, the conference room control program 1032 sends the text file to all of the conference members by wireless communication complying with the wireless LAN or Bluetooth(R).

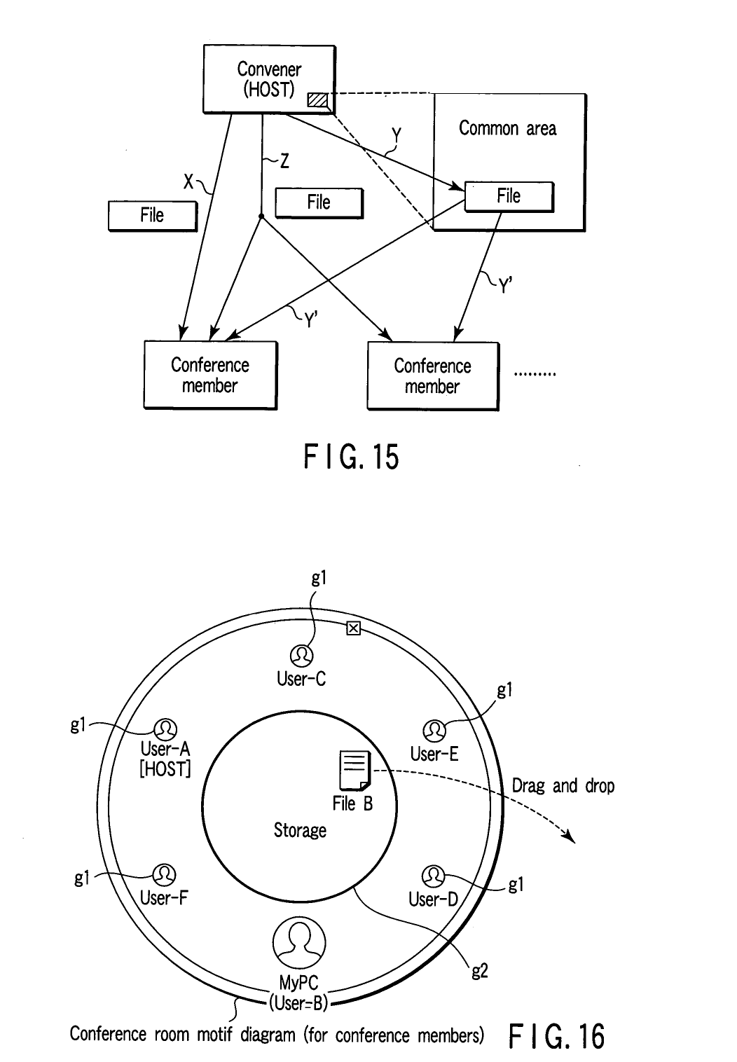

As described above, the convener can perform three types of data transmission and reception to and from the conference members, shown in FIG. 15, via the conference room screen of FIG. 7. Specifically, the convener can do the following easily and reliably: (1) the convener transmits data to a certain conference member separately (X), (2) the convener registers data in the common area and allows the conference members to download it (Y, Y′), (3) the convener transmits data to all of the conference member simultaneously (Z).

On the other hand, at PC(B) 1 to PC(F) 1 acting as conference members, the conference room screen of FIG. 10 is displayed. Using the conference room screen, each of the conference members can perform the following data transmission and reception.

First, each of the conference members can transmit data to the convener and the other conference members separately (corresponding to X in FIG. 15). As in the case of the convener shown in FIG. 11, the procedure for this is to just drag and drop the icon of the desired data file on the object g1 of the desired addressee. Data transmission to the other conference members can be executed when they are all wireless LAN devices or Bluetooth(R). If all of them are not wireless LAN devices or Bluetooth(R), the conference room control program 1032 displays an error message telling that data exchange with the addressee can not be performed. FIG. 10 shows a conference room indicated at PC(B) 1. [HOST] is attached under object g1 representing PC(A) 1.

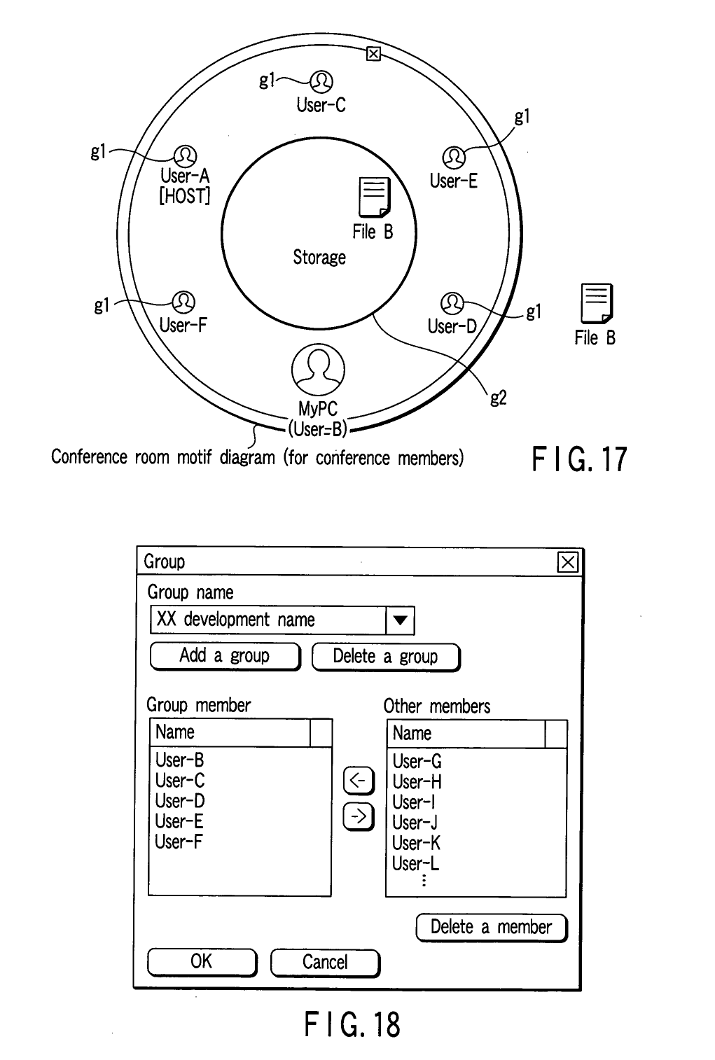

Second, each of the conference members can download data (common data) opened by the convener (corresponding to Y′ in FIG. 15). To download certain common data, each of the conference members has only to drag and drop the icon of the desired common data superimposed on object g2 in the common area outside the round table. After the drag and drop operation, the conference room control program 1032 displays a copy of the icon in the drop position as shown in FIG. 17, and transmits a data transfer request added with the identifier of the icon to the convener and stores the data returned in response to this into the HDD 16.

Third, each of the conference members can upload the data the member has to the common area (managed by the convener) as common data (corresponding to Y in FIG. 15). To upload certain data, each of the conference members has only to drag and drop the icon on object g2 in the common area as in the case of the convener shown in FIG. 12. After the drag and drop operation, the conference room control program 1032 displays a copy of the icon on object g2, and transmits a common data registration request notice added with the text file to the convener. Receiving the notice, the conference room control program 1032 on the convener side stores the text file into the HDD 16, and records information that the text file is a common file as conference room management data 202 into the HDD 16 and displays the icon on object e3. At this time, the conference room control program 1032 transmits common data registration notice added with the identifier of the text file to all of the conference members. Although direct data transmission and reception between a wireless LAN device and a Bluetooth(R) device are impossible, use of the upload makes it possible to perform data transmission and reception between a wireless LAN device and a Bluetooth(R) device by way of the convener.

As described above, since the conference room control program 1032 operates as described above for each of the cases where the user acts as the convener and where user acts as a conference member, an inter-face for performing data transmission and reception easily and reliably can be realized with a small-scale system configuration without using a special server unit.

On the conference room creating screen shown in FIG. 5, an arbitrary group can be created to make it possible to summon the same conference members again easily as in, for example, a regular conference. In this case, the convener clicks edit button c3 in FIG. 5. After edit button c3 has been clicked, the conference room control program 1032 displays a group setting screen shown in FIG. 18. The group created on the group setting screen is recorded as conference room management data 202 into the HDD 16. After such a group has been created, the conference room control program 1032 lists the created group on list C4 for selecting a group. When a group has been selected from the list c4, the conference room control program 1032 displays the individual conference members identified in the conference room management data 202 in table form, and grasps the result of the search of them from the search device management data 201 and displays the status. This makes it possible to do the work of creating the conference room efficiently, which improve the usability.

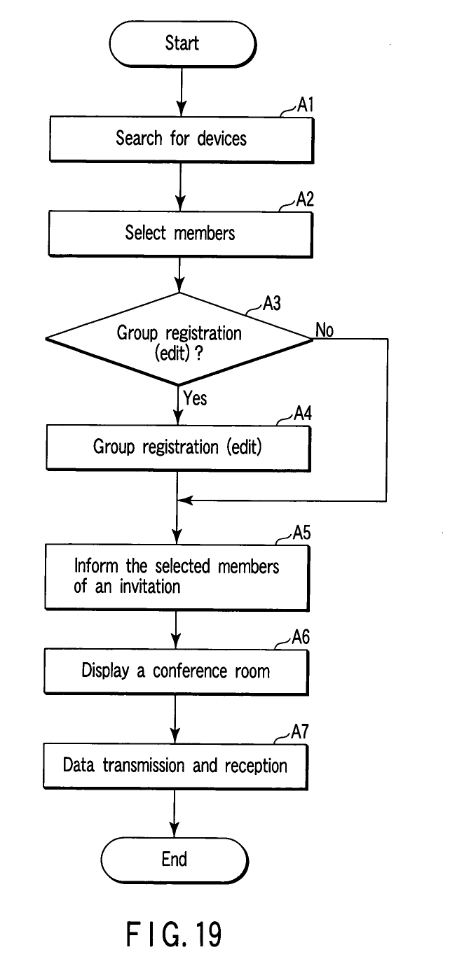

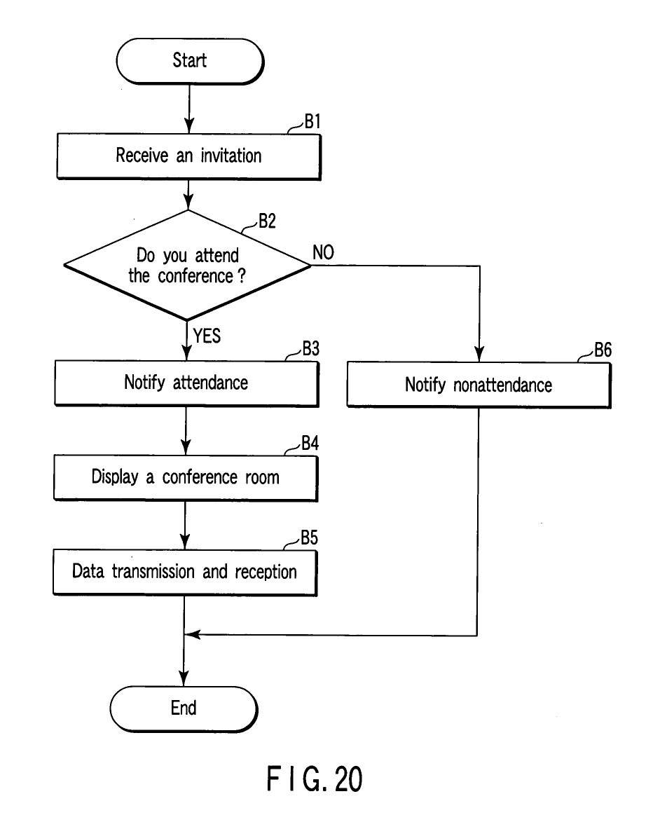

Next, referring to FIGS. 19 and 20, the procedure for controlling data transmission and reception performed by the electronic apparatus of the embodiment will be explained. FIG. 19 is a flowchart to help explain the operation of the electronic apparatus when the convener creates a conference room.

When the user acting as the convener uses the device, the device search control program.1031 first searches for wireless devices (step A1). After the search for wireless devices has been made, the conference room control program 1032 is activated, thereby selecting members for a conference to be summoned from the wireless devices searched for (step A2). If a group of members selected at this time is registered as a group (YES in step A3), the registration of the group is further carried out (step A4).

When the members have been selected, the conference room control program 1032 asks each of the selected members whether to participate in the conference room, and displays a conference room as if the members and the convener sit at a round table (step A6). Then, on the basis of the operations on the displayed conference room, the conference room control program 1032 executes data transmission and reception to and from each of the conference members (step A7).

FIG. 20 is a flowchart to help explain the operation of the electronic apparatus when a user participates in the conference room as one of the conference members.

When a user acting as a conference member uses the device, the user is asked whether to participate in the conference room, which activates the conference room control program 1032 (step B1). The activated conference room control program 1032 displays a notice as to whether to participate in the conference room (step B2). If the user decides on participation (YES in step B2), the conference room control program 1032 informs the convener of the participation (step B3) and displays a conference room as if the convener and the member reported by the convener sit at a round table (step B4). Then, on the basis of the operations on the displayed conference room, the conference room control program 1032 executes data transmission and reception to and from each of the conference members (step B5).

If the user decides on nonparticipation (NO in step B2), the conference room control program 1032 informs the convener of the nonparticipation (step B6) and ends the process without doing any thing.

As described above, the electronic apparatus provides an interface for performing data transmission and reception to and from each of the participating members in the conference room easily and reliably for each of the cases where the user of the electronic apparatus acts as a convener and where the user acts one of the conference members.

While in the embodiment, text files or the like created by word-processing software have been transmitted and received between the members participating in the conference room, the present invention is not limited to this. This invention may be practiced or embodied in still other ways without departing from the spirit or essential character thereof. For instance, after the destination is specified using a displayed object imitating a conference room, voice is input through a microphone and transmitted to the desired addressee.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus comprising:
means for searching other electronic apparatuses to be communicated;
a memory configured to store data;
a display controller configured to display first objects representing the other electronic apparatuses searched by the searching means, a second object representing the present apparatus, a third object representing a common area for the present apparatus to share the data with the other electronic apparatuses represented by the first objects, and a fourth object representing the data; and
a controller configured to share the data represented by the fourth object with the other electronic apparatuses represented by the first objects, when a specific operation for relating the fourth object to the third object is conducted.

2. The electronic apparatus according to claim 1, wherein the specific operation is an operation of superimposing the fourth object on the third object.

3. The electronic apparatus according to claim 1, wherein the controller transmits the data represented by the fourth object to the other electronic apparatuses represented by the first objects, when a specific operation for relating the fourth object to the first objects is conducted.

4. The electronic apparatus according to claim 1, wherein the display controller displays the first objects and the second object in such a manner that they surround the third object.

5. The electronic apparatus according to claim 1, wherein the display controller arranges the first objects and the second object on a concentric circle at equal intervals, with the third object at the center of the concentric circle.

6. The electronic apparatus according to claim 1,
wherein the controller manages information for registering a group composed of the electronic apparatuses searched by the searching means.

7. An electronic apparatus comprising:
means for searching other electronic apparatuses to be communicated;
a memory configured to store data;
a display controller configured to display first objects representing the other electronic apparatuses searched by the searching means, a second object representing the present apparatus, a third object representing a transmission area for transmitting the data to the other electronic apparatuses represented by the first objects, and a fourth object representing the specific data; and
a controller configured to transmit the data represented by the fourth object to the other electronic apparatuses represented by the first objects, when a specific operation for relating the fourth object to the third object is conducted.

8. The electronic apparatus according to claim 7, wherein the specific operation is an operation of superimposing the fourth object on the third object.

9. The electronic apparatus according to claim 7, wherein the controller transmits the data represented by the fourth object to the other electronic apparatuses represented by the first objects, when a specific operation for relating the fourth object to the first objects is conducted.

10. The electronic apparatus according to claim 7, wherein the display controller displays the first objects and the second object in such a manner that they surround the third object.

11. The electronic apparatus according to claim 7, wherein the display controller arranges the first objects and the second object on a concentric circle at equal intervals, with the third object at the center of the concentric circle.

12. The electronic apparatus according to claim 7,
wherein the controller manages information for registering a group composed of the electronic apparatuses searched by the searching means.

13. An electronic apparatus comprising:
a display controller configured to display first objects representing electronic apparatuses already participating in a conference, a second object representing the present apparatus, a third object representing a common area for the present apparatus to share data with the electronic apparatuses represented by the first objects, and a fourth object representing the data, when being required by another electronic apparatus to participate in the conference;
a memory configured to store data; and
a controller configured to acquire data represented by the forth object and to store the acquired data in the memory, when the operation of moving the fourth object outside the display area of the third object is conducted.

14. The electronic apparatus according to claim 13, wherein the controller transmits the data represented by the fourth object as common data to the other electronic apparatuses, when a specific operation for relating the fourth object to the third objects is conducted.

15. The electronic apparatus according to claim 13, wherein the controller transmits the data represented by the fourth object to the other electronic apparatuses represented by the first objects, when a specific operation for relating the fourth object to the first objects is conducted.

16. The electronic apparatus according to claim 13, wherein the display controller displays the first objects and the second object in such a manner that they surround the third object.

17. The electronic apparatus according to claim 13, wherein the display controller arranges the first objects and the second object on a concentric circle at equal intervals, with the third object at the center of the concentric circle.
